(19) United States
(12) Patent Application Publication
(10) Pub. No.: US 2026/0192788 A1
(43) Pub. Date: Jul. 9, 2026

(54) METHOD FOR OPERATING A BRAKE SYSTEM AND BRAKE SYSTEM

(71) Applicant: Robert Bosch GmbH, Stuttgart (DE)

(72) Inventors: Benjamin Heinz, Eberstadt (DE); Jens Kolarsky, Bietigheim/Bissingen (DE)

(21) Appl. No.: 19/133,748

(22) PCT Filed: Jun. 10, 2024
(86) PCT No.: PCT/EP2024/065966

§ 371 Date: May 29, 2025

(30) Foreign Application Priority Data
Jun. 21, 2023 (DE) 10 2023 205 831.6

(51) Int. Cl. B60T 13/66; B60T 8/171; B60T 13/68; B60T 17/22

(52) U.S. Cl. CPC B60T 13/662; B60T 8/171; B60T 13/686; B60T 17/22; B60T 2270/402; B60T 2270/406

(57) ABSTRACT

A brake system including a primary brake actuator and a secondary brake actuator. A target brake pressure is to be set by means of the primary brake actuator. In a first monitoring phase, the secondary brake actuator monitors the primary brake actuator to ascertain whether the target brake pressure is present. If the target brake pressure is not present, the secondary brake actuator hydraulically interrupts at least one hydraulic connection between the primary and the secondary brake actuator.

### BACKGROUND INFORMATION

Germany Patent Application No. DE 10 2009 001 135 A1 describes methods for actuating a hydraulic vehicle brake system comprising an electromechanical brake booster and a wheel slip control system. The present invention proposes actuating the vehicle brake system comprising the brake booster in situations in which a brake pedal is not actuated, for example to limit a vehicle speed or control the distance to a preceding vehicle, or when parking.

### SUMMARY

The present invention relates to a method for operating a brake system comprising a primary brake actuator and a secondary brake actuator. A target brake pressure is to be set by means of the primary brake actuator.

According to an example embodiment of the present invention, in a first monitoring phase, the secondary brake actuator monitors the primary brake actuator to ascertain whether the target brake pressure is present, i.e., whether this target brake pressure is actually set. If the target brake pressure is not present, the secondary brake actuator hydraulically interrupts at least one hydraulic connection between the primary and the secondary brake actuator.

According to an example embodiment of the present invention, the primary brake actuator can be a by-wire actuator, the secondary brake actuator can be an ESP hydraulic unit which is hydraulically connected to the by-wire actuator. Together, the primary and the secondary brake actuator form a by-wire brake system in which there is no hydraulic or mechanical connection between the brake pedal/a brake actuation unit and the primary and the secondary actuator. In other words, the brake pedal/brake actuation unit and the brake actuators are hydraulically and mechanically independent of one another. The primary and the secondary brake actuator are both connected to a brake actuation unit; either to a control device of the brake actuation unit or directly to corresponding sensors (e.g. travel sensor, force sensor, etc.) . The by-wire connection of the brake actuation unit advantageously makes it possible to forward a brake specification from a driver or from other vehicle systems to the primary and the secondary actuator promptly and quickly. To create redundancy and fail-safety, the brake specification can easily be converted into a target brake pressure by both actuators. The monitoring of the function of the primary brake actuator by the secondary brake actuator enables the secondary brake actuator to react appropriately if the primary brake actuator is behaving incorrectly.

One reaction can be to first close the change-over valves of the ESP hydraulic unit to thus lock in the pressure present in the ESP system and prevent an unwanted pressure drop in the ESP system, i.e., in the secondary brake actuator. Since the change-over valves comprise parallel-connected check valves that enable a flow of the hydraulic fluid in the direction of the wheel brakes, the primary brake actuator can continue to build up pressure as long as it is still functional.

In one example embodiment of the method of the present invention, the secondary brake actuator continues to monitor the primary brake actuator in a second monitoring phase to ascertain whether the target brake pressure is still not present. If it is still not present, the secondary brake actuator takes over the braking functions of the primary brake actuator. This increases the safety of the overall system. Because the secondary actuator takes over, braking can be taken over and continued largely unnoticed by the driver. If brake fluid is locked in under pressure by closing the valves and braking is continued by means of the second actuator, there is no or only an imperceptible fluctuation in the target brake pressure and thus in the braking effect.

According to an example embodiment of the present invention, it is also advantageous that, in the first monitoring phase, non-presence is determined if the target brake pressure is undershot for a first period of time, in particular if it is undershot by a first amount. A defect in the primary brake actuator can be thus be determined promptly after the end of the first time phase if the target brake pressure is undershot, and a first measure can promptly be implemented. Monitoring not only for undershooting and the first period of time, but also for an amount of undershooting, makes it possible to adjust the initiation of the measure (closing the change-over valves) in relation to the time or the severity of undershooting. It is also advantageous that, in the second monitoring phase, a non-presence is determined if the target brake pressure is undershot for a second period of time, in particular if it is undershot by a second amount.

In an advantageous example embodiment of the present invention, the second period of time is greater than the first period of time. It is therefore possible to react quickly to a detected pressure drop and thus a suspected failure of the primary brake actuator with a shorter first period of time, and then use a longer time frame to see whether the primary brake actuator is really defective. Continued operation of the primary brake actuator via the parallel-connected check valves of the change-over valves is known to still be possible.

In one example embodiment of the present invention, the hydraulic interruption between the primary brake actuator and the secondary brake actuator is accomplished by means of at least one change-over valve of the secondary brake actuator. Brake pressure can thus easily be maintained using means already present in the secondary brake actuator and used for potential continued operation by the secondary brake actuator.

In another example embodiment of the method of the present invention, the primary brake actuator and the secondary brake actuator are controlled with an identical brake specification. A brake specification is understood to be a braking request or a braking intention, which can be specified by a driver or come from another vehicle system. The braking request, brake specification or braking intention can all include the fact that braking should take place and also how hard braking should be. Another vehicle system (such as traffic jam following, distance control) can also give the brake system a specification for how hard braking should be. It is advantageous if both brake actuators receive the same brake specification, because it is then possible for the secondary brake actuator to take over the braking function from the primary brake actuator without the secondary brake actuator having to derive, estimate or calculate the brake specification from other variables, which can lead to an unwanted time delay. A brake specification can thus be implemented easily and quickly in a by-wire brake system, while ensuring increased fail-safety. The brake actuators are controlled electronically via corresponding signal lines or communication networks present in the vehicle.

In a further development of the method of the present invention, the target brake pressure to be set by the primary and/or the secondary brake actuator for a brake specification is stored in in the primary and the secondary brake actuator based on a brake specification-target brake pressure relationship. The brake specification-target brake pressure relationship in the two brake actuators can be identical. As mentioned, this has the advantage that the secondary brake actuator can take over braking functions reliably and quickly.

When the braking functions of the primary brake actuator are taken over by operating the secondary brake actuator, at least one high-pressure switching valve of the secondary brake actuator is opened during its operation in order to supply it with hydraulic fluid. The secondary brake actuator can thus receive the hydraulic fluid needed to build up pressure.

The present invention further comprises a brake system comprising a primary brake actuator and a secondary brake actuator and means for carrying out a method of the present invention as described herein. The present invention also comprises a computer program which is configured to carry out the steps of the method and a machine-readable storage medium on which the computer program is stored.

### BRIEF DESCRIPTION OF THE DRAWINGS

FIG. 1 shows a brake system in a first operating situation, according to an example embodiment of the present invention.

FIG. 2 shows a brake specification-target brake pressure relationship with entered values, according to an example embodiment of the present invention.

FIG. 3 shows the brake system in a second operating situation, according to an example embodiment of the present invention.

FIG. 4 shows the brake system in a third operating situation, according to an example embodiment of the present invention.

FIG. 5 shows the brake system in a fourth operating situation, according to an example embodiment of the present invention.

FIG. 6 shows a process sequence for operating a brake system of a vehicle, according to an example embodiment of the present invention.

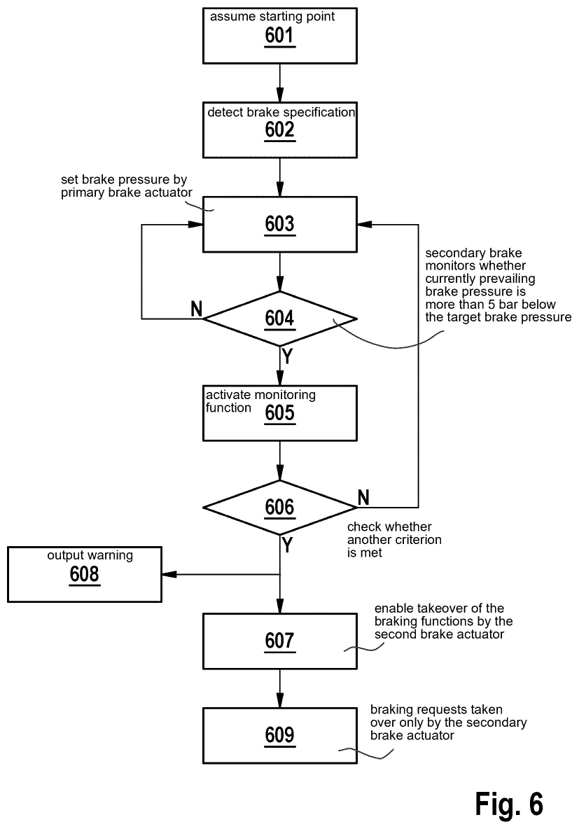

### DETAILED DESCRIPTION OF EXAMPLE EMBODIMENTS

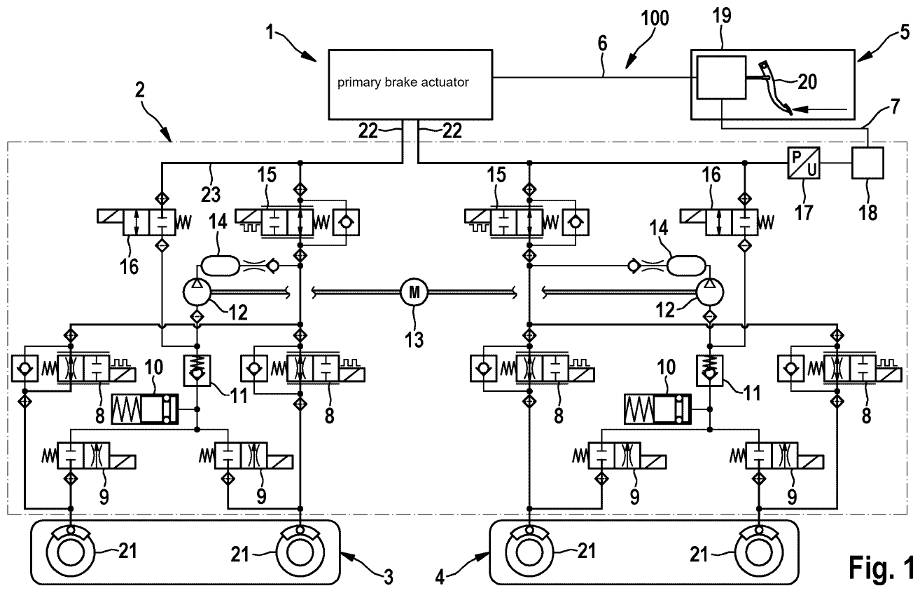

FIG. 1 shows a schematic illustration of a brake system 100 comprising a primary brake actuator 1 and a secondary brake actuator 2. The primary brake actuator 1 and the secondary brake actuator 2 are controlled by an actuating unit 5 with signals 6 and 7. The actuating unit 5 can detect actuation of the brake system by a driver via a brake actuating element 20 of a vehicle, for example, with a sensor unit 19. The signals 6 and 7 thus correspond to an existing braking request.

A brake specification can also be provided by other vehicle systems, for instance automated driving systems, a system for automatic following driving or also emergency braking systems. Such systems are not shown here for the sake of simplicity.

The primary brake actuator 1 and the secondary brake actuator 2 are both able to generate brake pressure in connected hydraulic brake circuits 3 and 4 on the respective connected hydraulic wheel brakes 21 and thus generate a braking effect for the vehicle in a conventional manner, for example via brake pads and brake discs. Both brake actuators 1 and 2 are able to independently build up brake pressure at the wheel brakes.

The primary brake actuator 1 is provided as a by-wire brake actuator that is controlled by means of signals, for example signal 6 from the actuating unit 5. Such a primary brake actuator 1 can comprise a control unit that controls a motor unit. The motor unit can use a gearing to, directly or via intermediate components such as springs or further pistons, move an input piston of a master brake cylinder that delimits a hydraulic chamber of the master brake cylinder. Moving the input piston applies force to hydraulic fluid in the chamber which pushes it in the direction of the output lines 22 and thus ultimately allows a hydraulic pressure to be set in the brake system. Other designs of the primary brake actuator 1, such as pumps or accumulators, are possible.

The secondary brake actuator 2 can be connected to output lines 22. This is depicted in FIG. 1 as a classic brake control system, the elements of which are briefly discussed in the following. Like the primary brake actuator 1, the secondary brake actuator 2, too, can be controlled by the actuating unit 5 solely on the basis of signals, such as signal 7, and set a brake pressure. For this purpose, the secondary brake actuator 2 comprises a hydraulic pump 12 in each brake circuit 3 and 4 that can be driven by a motor 13. If the pump 12 is conveying hydraulic fluid in the direction of individual or multiple wheel brakes 21, the brake pressure can be generated at said wheel brakes. Targeted brake pressure generation at individual ones of the multiple wheel brakes 21 can be accomplished using existing hydraulic valves. In the hydraulic lines leading to each wheel brake 21, there are inlet valves 8, for example controllable, normally open valves, with a check valve in parallel that prevents hydraulic flow to the wheel brakes.

Leading away from the wheel brakes, there are outlet valves 9 in the form of switchable, normally closed valves without check valve. The outlet valves 9 connect the wheel brakes to a hydraulic accumulator 10, which, together with the outlet valves 9, is connected to the suction side of the pump 12 via a check valve 11. The check valve 11 allows hydraulic flow in the direction of the pump. The outlet valves 9 are normally closed valves. Also connected to the suction side of the pump 12 is a hydraulic connection to a high-pressure switching valve 16, which is switchable, normally closed, does not have a check valve, and with its other side is connected to one of the hydraulic lines 22 of the primary brake actuator 1.

On the pressure side of the pump are elements 14 that influence the hydraulic flow from the pump 12, such as a damper, and a check valve that allows hydraulic flow away from the pump.

The pressure side of the pump 12 is connected to one of the hydraulic lines 22 of the primary brake actuator 1 via a normally open valve 15, which comprises a check valve that allows hydraulic flow from the primary brake actuator 1 in the direction of the inlet valves 8. The pressure side is also connected to the associated inlet valves 8. The valves 15 are so-called change-over valves, which are controllable and comprise said normally open check valve.

In situations that require brake control intervention, for example to implement anti-lock functions, traction control or skid protection, brake pressure can be increased or reduced individually for each wheel, either directly via the primary brake actuator 1 or also with the involvement of the hydraulic pumps 12, the accumulator chamber 10 and accordingly to be set valves in a conventional manner.

Normal braking is usually accomplished by means of the primary brake actuator 1, which can generate brake pressure at the wheel brakes 21 via the hydraulic lines 22, the valves 15 and the inlet valves 8. The outlet valves 9 are then closed.

The hydraulic lines 23 emphasized in FIG. 1 (also including the lines 22) show where the associated brake pressure is present in the secondary brake actuator 2 when pressure is generated by the primary brake actuator 1. It can be seen that the brake pressure reaches the wheel brakes 21 and, because of the closed valves 16 and the closed outlet valves 9, cannot pass through them.

The thus prevailing brake pressure p_actual can be ascertained by means of a pressure sensor 17.

In order to adequately implement a brake specification, i.e. for example a driver braking request, the brake specification has to be ascertained. This can be acquired using a travel s of a brake pedal 20, for example, which is acquired by means of sensors 19. This travel s can be fed to the primary and the secondary brake actuator 1, 2 as a signal 6 or 7. A preprocessing of the signal is possible as well. Instead of an actuation path, it is also possible to acquire an actuation force, an actuation pressure, an actuation speed or correlated variables. For the sake of simplicity, the following is based on a braking request s that is present in a certain amount or to a certain extent.

A brake specification can also be output directly by other vehicle systems that do not necessarily refer back to a driver input.

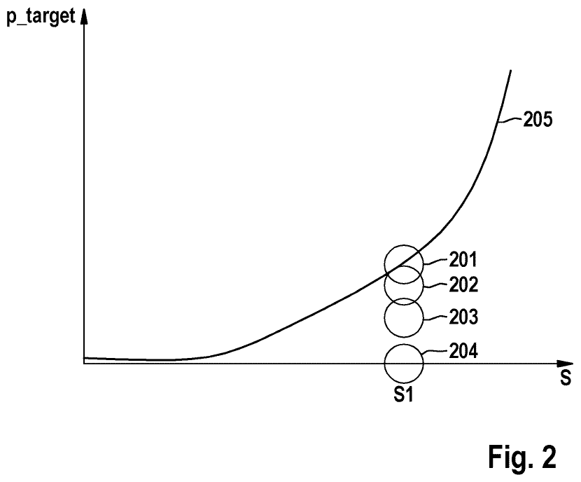

An expected brake pressure p_target, which is set by the primary brake actuator 1, can be assigned to the brake specification s using a characteristic curve 205. If the primary brake actuator 1 is intact, a brake pressure p_target according to label 201 is obtained in FIG. 2 for a brake specification s1.

The characteristic curve 205 is stored or present in both brake actuators 1, 2. Thus, both brake actuators 1, 2 know which brake pressure p_target should be set for the respective brake specification s transmitted as signals 6, 7.

The following assumes that the primary brake actuator 1 can no longer generate the brake pressure p_target that matches the brake specification s1, or can no longer generate it completely. This can manifest itself in that a lower brake pressure according to label 202 is set, even though a value according to 201 is expected.

This can be ascertained in the secondary brake actuator 2 by means of the control device 18, to which brake pressure sensor 17 is connected.

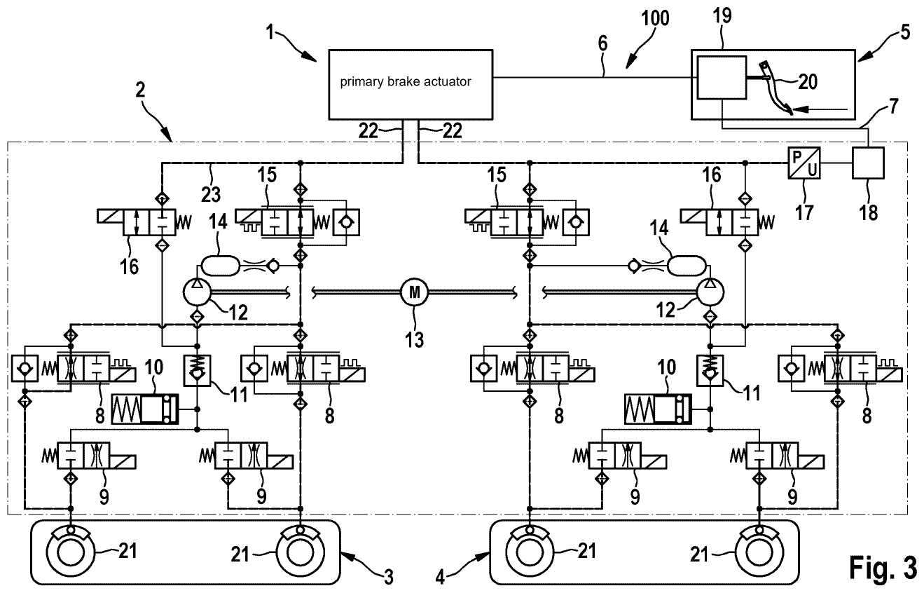

FIG. 3 shows the prevailing brake pressure 23 in the system, which essentially corresponds to the brake pressure distribution of FIG. 1 but, according to the label 202, is lower in FIG. 2. If the brake pressure in FIG. 1 was 60 bar, for instance, then only 50 bar may still be present in FIG. 3.

If the lower brake pressure 202 is present for longer than a first period of time t1, the change-over valves 15 in the secondary brake actuator 2 are closed. This locks in the remaining pressure in the hydraulic lines of the secondary brake actuator 2. A period of time can be 10 milliseconds, for example, after which the change-over valves 15 are closed. The change-over valves 15 comprise parallel-connected check valves that enable a flow of hydraulic fluid in the direction of the wheel brakes. Thus, if the primary brake actuator 1 is still functional after all, the primary brake actuator can continue to build up pressure at the wheel brakes.

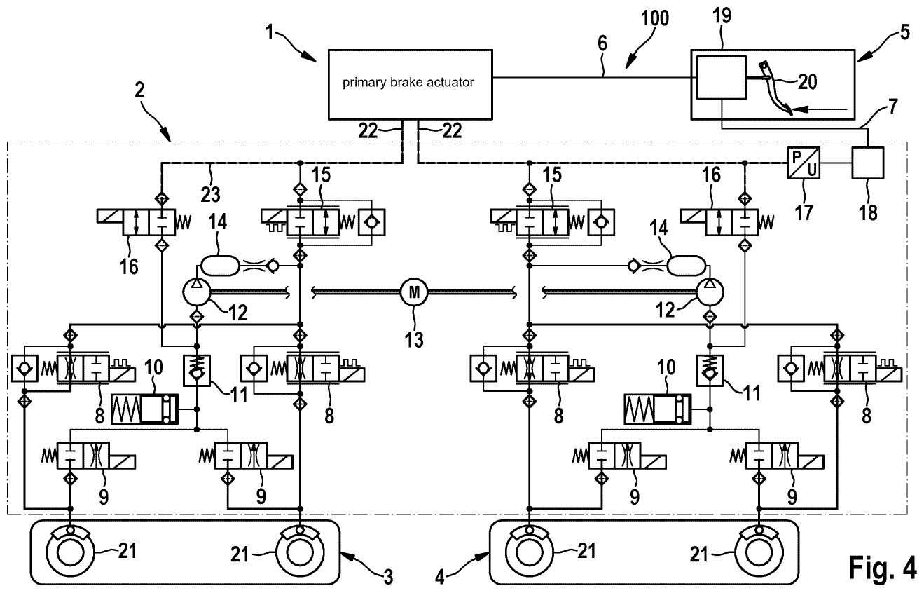

In FIG. 4, line 23a illustrates how the brake pressure generated by the primary brake actuator drops further to a value 203 as shown in FIG. 2. This further drop can be to 40 bar, for instance. In the part labeled as line 23b, the brake pressure of FIG. 3 is still present due to the closed valves 15, corresponding to label 202 in FIG. 2.

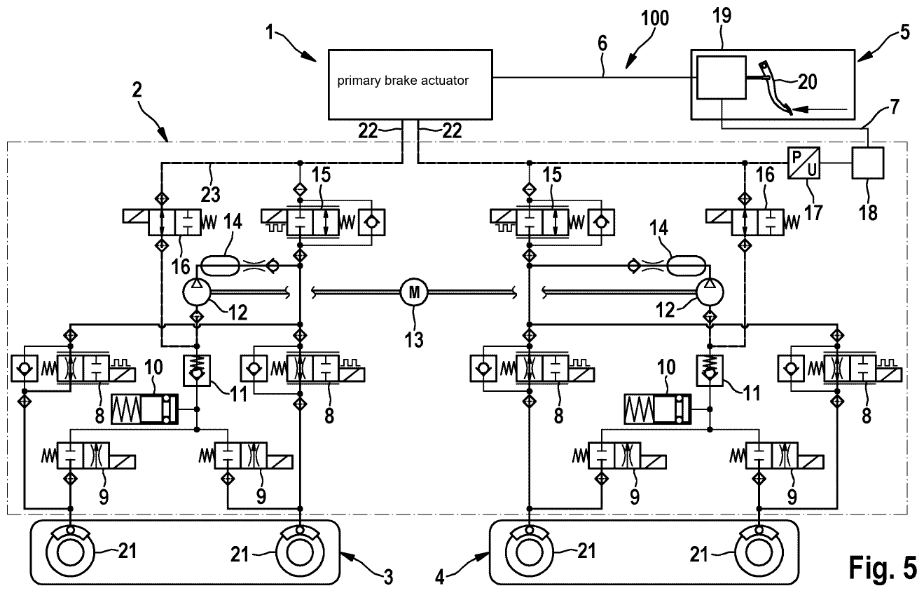

If the secondary brake actuator 2 determines by means of the pressure sensor 17 and the control device 18 that the brake pressure is less than the expected brake pressure (201 in FIG. 2) for a second period of time t2, the primary brake actuator is assumed to be defective. The secondary brake actuator takes over the tasks of the primary brake actuator and continues braking based on the brake specification s1. The brake pressure expected according to the characteristic curve 205 is then reset by means of the pumps 12 with the corresponding valve position (shown in FIG. 5). The change-over valves 15 remain closed; the valves 16 are opened so that the pumps 12 can draw in hydraulic fluid. The part of the hydraulic lines labeled as line 23b is then back at the initial pressure level 201, which is to be set based on the braking request s1 using the characteristic curve 205. The pressure level, which is maintained by the primary brake actuator 1, may have dropped further, possibly even to zero (FIG. 2, label 204).

Once a defect in the primary brake actuator 1 has been detected, all braking functions are taken over and implemented by the secondary brake actuator 2.

The described process sequence is as follows.

In the initial step 601, a starting point is assumed in which both brake actuators, primary 1 and secondary 2, are functional.

In the next step 602, the brake specification s1 is detected and provided to the brake actuators 1, 2 as a signal 6, 7.

In the following step 603, the brake pressure 201 is set by the primary brake actuator 1 according to the brake specification s1 based on the characteristic curve 205.

In a monitoring step 604, the secondary brake actuator monitors whether the currently prevailing brake pressure p_actual is more than, for example, 5 bar below the target brake pressure p_target provided for the brake specification s1, and that for a first period of time t>t1. If this is the case, the method continues with step 605; if not, monitoring for undershooting is continued for a first period of time t1 and the pressure continues to be set with the primary brake actuator 1 in accordance with step 603.

In step 605, a monitoring function is activated in the secondary brake actuator 2 to check whether another criterion 606 is met. The valves 15 are moreover closed as well in order to lock in the brake pressure already set by the primary brake actuator 1, as described above.

In step 606, there is a check to see whether the current brake pressure p_actual is undershooting the target brake pressure p_target by, for example, more than 5 bar for a second period of time t>t2.

If this is the case, the takeover of the braking functions by the secondary brake actuator 2 is enabled in step 607. The valves 15 are kept closed, the valves 16 are opened and the pumps 12 are controlled, so that the target brake pressure according to the brake specification s1 is reached again based on the characteristic curve 205 by operating the secondary brake actuator 2.

In addition, in step 608, a warning (acoustic, visual, . . . ) can be output in the vehicle to call attention to the defect in the primary brake actuator.

In step 609, the braking requests are then taken over only by the secondary brake actuator 2, for example to keep the vehicle stationary, to accelerate the vehicle again, or carry out driver-induced and system-induced braking.

1-12. (canceled)

13. A method for operating a brake system, the brake system including a primary brake actuator and a secondary brake actuator, wherein a target brake pressure is to be set by the primary brake actuator, the method comprising the following steps:
in a first monitoring phase, monitoring by the secondary brake actuator the primary brake actuator to ascertain whether the target brake pressure is present; and
when the target brake pressure is not present, hydraulically interrupting, by the secondary brake actuator, at least one hydraulic connection between the primary brake actuator and the secondary brake actuator.

14. The method according to claim 13, wherein, in a second monitoring phase, the secondary brake actuator continues to monitor the primary brake actuator to ascertain whether the target brake pressure is still present, and, based on the target brake pressure not being still present, the secondary brake actuator takes over braking functions of the primary brake actuator.

15. The method according to claim 13, wherein, in the first monitoring phase, a non-presence is determined when the target brake pressure is undershot by a first amount for a first period of time.

16. The method according to claim 15, wherein, in the second monitoring phase, a non-presence is determined when the target brake pressure is undershot by a second amount for a second period of time.

17. The method according to claim 16, wherein the second period of time is greater than the first period of time.

18. The method according to claim 13, wherein the hydraulic interruption between the primary brake actuator and the secondary brake actuator is carried out using at least one change-over valve of the secondary brake actuator.

19. The method according to claim 13, wherein the primary brake actuator and the secondary brake actuator are electronically controlled with an identical brake specification.

20. The method according to claim 19, wherein the target brake pressure to be set by the primary and/or the secondary brake actuator for a brake specification is stored in the primary brake actuator and the secondary brake actuator based on a brake specification-target brake pressure relationship that is identical in the primary and secondary brake actuators.

21. The method according to claim 14, wherein, in order to take over the braking functions of the primary brake actuator by operating the secondary brake actuator, at least one high-pressure switching valve of the secondary brake actuator is opened during operation of the secondary brake actuator in order to supply the secondary brake actuator with hydraulic fluid.

22. A brake system, comprising:
a primary brake actuator;
a secondary brake actuator; and
an arrangement configured to operate a brake system, wherein a target brake pressure is to be set by the primary brake actuator, the arrangement configured to:
in a first monitoring phase, monitor by the secondary brake actuator the primary brake actuator to ascertain whether the target brake pressure is present, and
when the target brake pressure is not present, hydraulically interrupt, by the secondary brake actuator, at least one hydraulic connection between the primary brake actuator and the secondary brake actuator.

23. A non-transitory machine-readable storage medium on which is stored a computer program for operating a brake system, the brake system including a primary brake actuator and a secondary brake actuator, wherein a target brake pressure is to be set by the primary brake actuator, the computer program, when executed by a computer, causing the computer to perform the following steps:
in a first monitoring phase, monitoring by the secondary brake actuator the primary brake actuator to ascertain whether the target brake pressure is present; and
when the target brake pressure is not present, hydraulically interrupting, by the secondary brake actuator, at least one hydraulic connection between the primary brake actuator and the secondary brake actuator.
